(19) United States
(12) Patent Application Publication
(10) Pub. No.: US 2005/0134155 A1
(43) Pub. Date: Jun. 23, 2005

(54) Encryption unit quick insert/ quick removal housing

(76) Inventors: Steven S. Anspach, Tampa, FL (US); Richard Cart, Hudson, FL (US); Jay H. Frye, Valrico, FL (US)

Correspondence Address: Manelli Denison & Selter PLLC, 7th Floor, 2000 M Street, N.W., Washington, DC, 20036-3307, US

(21) Appl. No.: 10/667,788

(22) Filed: Sep. 23, 2003

(51) Int. Cl. A47B 81/00; H04K 1/00

(52) U.S. Cl. 312/223.1; 380/59

(57) ABSTRACT

A quick insert/quick release encryption unit mounting bracket allowing a Type 1 encryption device such as the KIV-7 to be quickly inserted and perhaps more importantly, quickly removed (e.g., in the event of the need for an extremely quick evacuation of a military site). The quick insert/quick release mounting bracket allows for removal of a Type 1 encryption device simply by pulling the encryption unit straight out in the direction of the front of the unit, without the need to physically unscrew or otherwise disconnect individual cable assemblies, or for insertion by simply sliding the encryption unit into place. This facilitates a quick swap out of an encryption unit in the event of failure, or in the event that the sensitive nature of the encryption unit needs to be quickly removed to protect the encryption unit from falling into enemy hands.

### BACKGROUND OF THE INVENTION

1. Field of the Invention

This invention relates generally to computer and communication networks, and more specifically, to a mounting method and bracket for the encryption unit portion of a deployable secure communication system used to provide secure voice, video and data services to multiple remote users.

2. Background of Related Art

Conventional deployable communication systems exist. For instance, FIG. 6 is a depiction of a particular conventional deployable secure communication system.

In particular, as shown in FIG. 6, a secure encryption module such as defined by KIV-7 standards 912 with suitable interface hardware is utilized in a direct connection path between a remote user 910 and a wireless connection to a similarly secure receiver via a satellite antenna 914. In the conventional system of FIG. 6, an ISDN link is utilized between the module 912 including a KIV-7 encryption module, and a suitable satellite two-way communication transceiver and antenna 914.

However, such conventional systems are typically physically large. Typical secure, deployable communications systems fill a van or small vehicle. Part of the reason for the significant size of such systems is the need to accommodate racks of communications equipment, including a rack-mounted, standardized encryption unit, e.g., a Type 1 KIV-type encryption device such as a KIV-7, pictured in FIG. 7.

In particular, FIG. 7 depicts the conventional casing and required connections to a KIV-7 unit.

As shown in FIG. 7, a KIV-7 unit 700 includes four separate connector sockets 710-716. Two of the connectors are 9-pin connectors, the other two are 37-pin connectors. One of the 9-pin sockets 710, 716 is a male-type connector, and the other 710, 716 is a female-type connector. Similarly, one of the 37-pin connectors 712, 714 is a male-type, while the other 712, 714 is a female-type. The use of male and female-type connectors prevents improper installation cabling to the KIV-7 700.

It should be noted that a KIV-7 has no handles, and is typically rack-mounted into a rack of equipment.

As can be appreciated from the KIV-7 encryption unit depicted in FIG. 7, a significant amount of access must be provided to the rear of the KIV-7 so that the KIV-7 may be replaced if maintenance is required. Such access is typical in most rack-mounted equipment enclosures.

Some conventional deployable secure communications terminals fill a van with equipment. As can be appreciated, in a military environment size is to be minimized so as to expand military options of deployment.

There is a need to reduce the size of a deployable secure communications system.

### BRIEF DESCRIPTION OF THE DRAWINGS

Features and advantages of the present invention will become apparent to those skilled in the art from the following description with reference to the drawings, in which:

FIG. 1 shows an exemplary quick insert/quick release encryption unit mounting bracket within a deployable secure communications system, in accordance with the principles of the present invention.

FIG. 2 shows an outside, rear view of an embodiment of the quick insert/quick release encryption unit mounting bracket shown in FIG. 1.

FIG. 3 shows a rear, floating connector plate of the quick insert/quick release encryption unit mounting bracket having 4 connectors mounted thereon to mate with complementary connectors mounted on the rear of the encryption unit, in accordance with the principles of the present invention.

FIGS. 4A to 4E show exemplary side, top and bottom components of a first embodiment of a quick insert/quick release encryption unit mounting bracket shown in FIG. 1.

FIGS. 5A and 5B show an exemplary separable T-shaped pull to allow quick separation of an installed KIV-7 unit from an encryption unit mounting bracket, in accordance with another aspect of the present invention.

FIG. 6 is a depiction of a particular conventional deployable secure communication system.

FIG. 7 depicts the conventional casing and required connections to a KIV-7 unit.

### SUMMARY OF THE INVENTION

In accordance with the principles of the present invention, a quick insert/quick release mounting bracket for an encryption unit comprises a top surface. A right surface is secured to the top surface. A bottom surface is secured to the right surface. A left surface is secured to the top surface. A rear surface having at least four connectors is mounted thereon. The connectors are normally associated with individually secured cables. The rear surface is movably secured in a rear of the mounting bracket so as to allow for a given amount of left/right and up/down tolerance in alignment between the at least four mounted connectors mounted on the rear surface and a matching at least four connectors on a rear of an encryption unit to be slid over the top surface, the bottom surface, the left surface, and the right surface, and into connection with the at least four mounted connectors.

### DETAILED DESCRIPTION OF ILLUSTRATIVE EMBODIMENTS

In a commercial environment where competitors offer portable, secure communication terminals that fill a van or small vehicle, one vendor, TeleCommunication Systems, Inc. (TCS) of Annapolis, Md., provides a portable secure communication terminal, and even a deployable secure communications terminal that is uniquely packaged to be small enough to be carried in a suitcase-sized enclosure. Current products from TCS are suitably small enough to be carried by a paratrooper, e.g., into hostile territory. This is significant as prior systems could not be deployed until an aircraft or other transport system carried them directly to the relevant location.

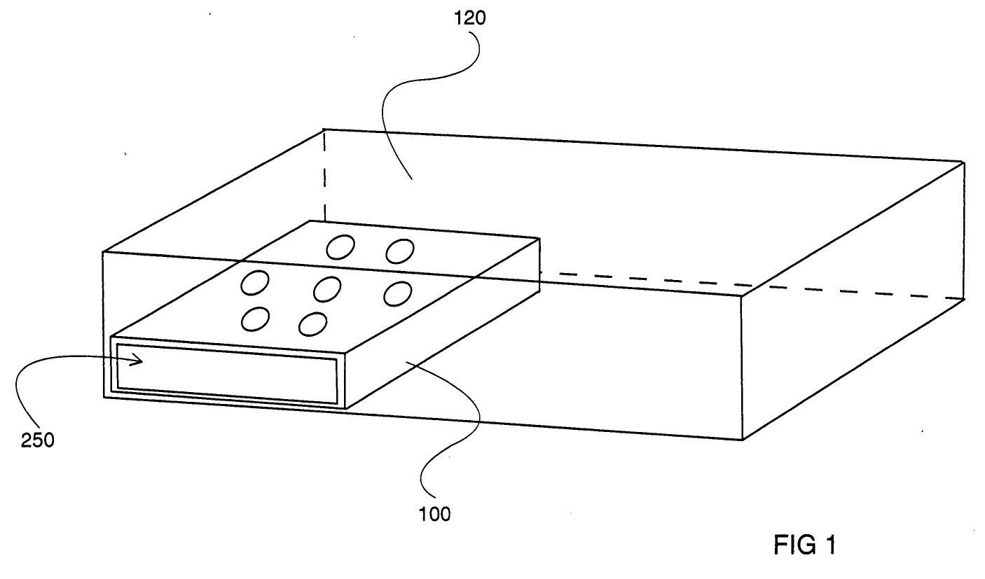

The reduction in size and weight requirements of a deployable, secure communications terminal are due in no small part to the development of a highly compact mounting bracket 100 for the heart of the secure system—the Type 1 KIV-type encryption unit, shown in FIG. 1.

A quick insert/quick release encryption unit mounting bracket 100 in accordance with the principles of the present invention is disclosed for an embodiment based on the KIV-7 700 (manufactured by Mykotronx) Type 1 encryption device. The disclosed quick insert/quick release mounting bracket 100 allows a Type 1 encryption device such as the KIV-7 700 to be quickly inserted and perhaps more importantly, quickly removed (e.g., in the event of the need for an extremely quick evacuation of a military site). Importantly, the disclosed quick insert/quick release mounting bracket 100 allows for removal of a Type 1 encryption device 700 such as a KIV-7 without the need to physically unscrew or otherwise disconnect individual cable assemblies.

In accordance with the principles of the present invention, the disclosed quick insert/quick release encryption unit mounting bracket 100 allows a Type 1 encryption device 700 such as a KIV-7 to be inserted by simply sliding the KIV-7 700 into place, or to be removed by simply pulling the KIV-7 700 straight out in the direction of the front of the unit. This facilitates a quick swap out of the KIV-7 700 in the event of failure, or in the event that the sensitive nature of the encryption unit 700 needs to be quickly removed to protect the encryption unit 700 from falling into enemy hands.

The KIV-7 700 is typically installed into a multi-bay rack mount shelf assembly that contains a power supply, or in some cases simply placed on a shelf. The design of the KIV-7 700 requires the physical connection of a minimum of three cable assemblies; power input, data input, and data output. The process of inserting the KIV-7 700 into the shelf assembly and connecting the three cable assemblies typically requires several minutes of an individuals time and open access to the rear of shelf for connection and securing of the cable assemblies. Removal of the KIV-7 700 also requires several minutes of time and open access to its rear, typically provided by a rack mount enclosure. Typical rack mount enclosures are 6 feet tall, 2 feet wide, by 3 feet deep.

Through the implementation of the disclosed encryption unit mounting bracket 100, an encryption unit 700 such as a KIV-7 can now be inserted and ready for operation in a matter of just a few seconds. Importantly, the mounting bracket 100 need not provide a routine operator with access to the rear of the encryption unit 700, further facilitating a quick release of the encryption unit 700.

If removal of the bracketed encryption unit 700 becomes required, the encryption unit 700 may be gripped (e.g., by use of the key) and pulled out in just a few seconds without the need for direct access to the rear of the unit.

Conventional installations of a Type 1 encryption unit 700 such as the KIV-7HS or other KIV-type devices (e.g., a KIV-21) required cabling to the rear of the unit 700. The present invention enables the installation and removal of a Type 1 encryption unit 700 without the need to secure or remove numerous cables connected to the rear of the encryption unit 700.

FIG. 1 shows an exemplary quick insert/quick release encryption unit mounting bracket within a deployable secure communications system, in accordance with the principles of the present invention.

In particular, FIG. 1 shows an exemplary quick insert/quick release encryption unit housing and mounting bracket 100 placed within a casing 120 intended to contain a deployable, secure communications terminal.

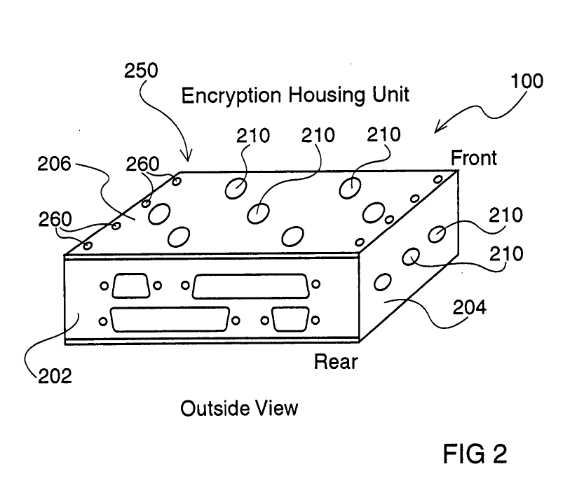

FIG. 2 shows an outside, rear view of the exemplary embodiment of the quick insert/quick release encryption unit mounting bracket shown in FIG. 1.

In particular, FIG. 2 shows a rear plate 202 for fixedly mounting connectors to mate with appropriate connectors on the rear of a Type 1 encryption unit such as the KIV-7. The quick insert/quick release mounting bracket 100 further includes a top 206 (and matching bottom not shown), a left side 204 and a matching right side (not shown).

The top 206, bottom, left side 204 and right side of the quick insert/quick release mounting bracket 100 preferably include holes or other shaped cut-out areas 210. The cut-out areas 210 provide a reduction in the weight of the overall secure, deployable communications terminal. Moreover, the cut-out areas 210 also provide for cooling of the KIV-7, which fits snugly inside the quick insert/quick release mounting bracket 100, with sufficient tolerances to allow easy sliding of the KIV-7 into the quick insert/quick release mounting bracket 100 from its front end 250.

The bracket may be made of any suitable metal, e.g., aluminum. In such case, individual sides, top and bottom may be made separately from flat stock, and screwed together with appropriate screws 260. The bracket may also be manufactured from a plastic material, e.g., Delron™. Because plastics tend to insulate thermally more than do metals, the use of cut-out areas 210 are more important from a ventilation point of view. The quick insert/quick release mounting bracket 100 may also be formed in a singular piece of metal or plastic. A combination of plastic and metal portions is also possible.

Importantly, the rear plate 202 of the quick insert/quick release mounting bracket 100 is not fixedly mounted to the sides, top or bottom of the quick insert/quick release mounting bracket 100. Rather, it is captured in appropriate slots in the top, bottom and sides and left floating with some amount of tolerance (e.g., ⅛″ in left/right and up/down directions). This ‘floatation’ allows movement of the connectors mounted to the rear plate 202 with respect to the matching connectors on the rear of the KIV-7 upon insertion of the KIV-7 into the mounting bracket 200. This ‘floatation is important because of variances in the exact placement of the connectors with respect to the rear of the KIV-7 unit 700.

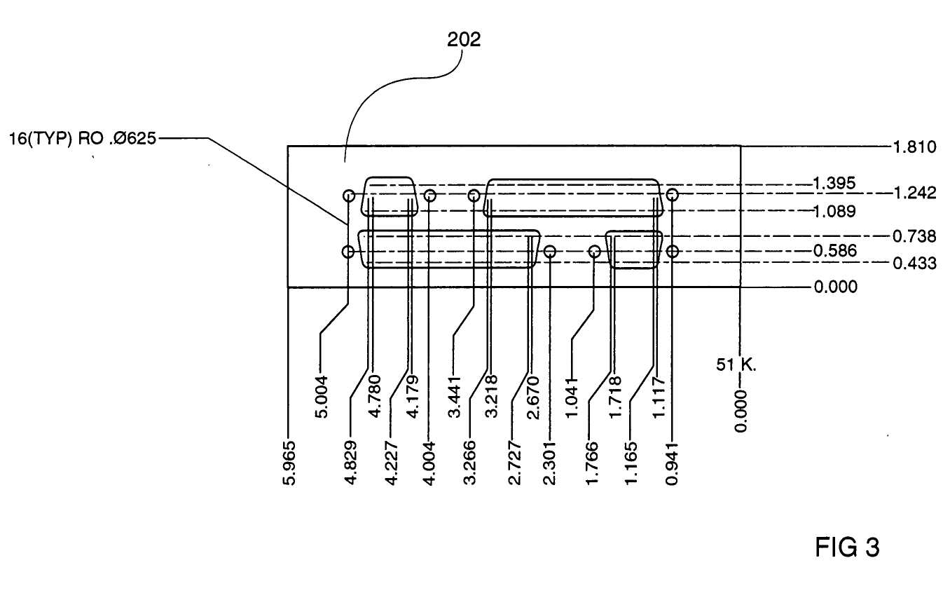

FIG. 3 shows the rear, floating connector plate 202 of the quick insert/quick release encryption unit mounting bracket having 4 connectors mounted thereon to mate with complementary connectors mounted on the rear of the encryption unit, in accordance with the principles of the present invention.

In particular, FIG. 3 shows particularly measured placements of the connectors on the rear plate 202. Of course, these measured placements relate to the exemplary KIV-7 in particular used in the disclosed embodiments. However, the invention is to be understood as relating to KIV-type encryption units in general.

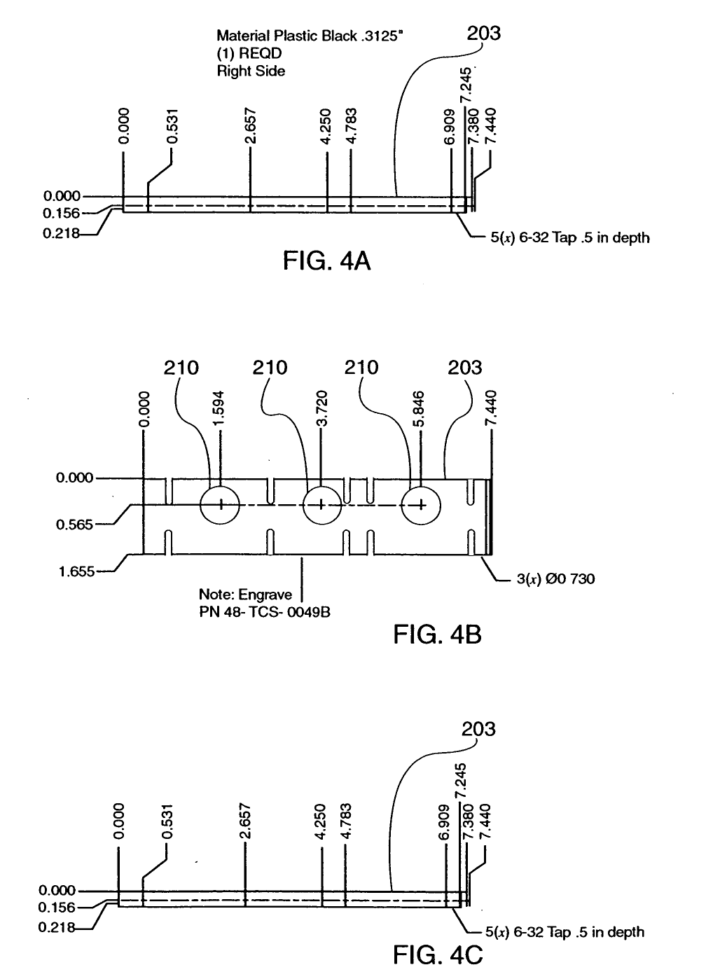

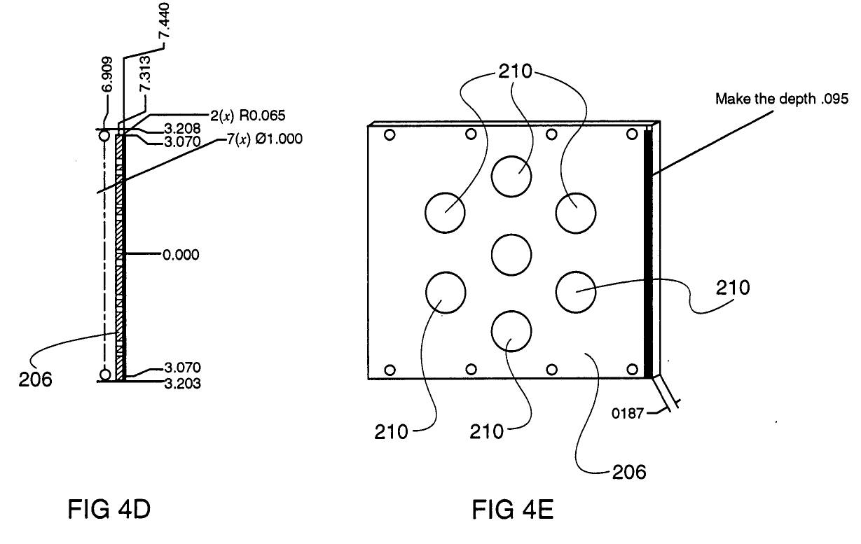

FIGS. 4A to 4E show exemplary side, top and bottom components of a first embodiment of a quick insert/quick release encryption unit mounting bracket shown in FIG. 1.

In particular, FIGS. 4A to 4C show views of the right side 203 of the quick insert/quick release encryption unit mounting bracket 100, including the exemplary cut-out areas 210. FIGS. 4D and 4E show views of the top 206. The bottom in a first embodiment is the same as the top 206. However, the bottom (or top 206) surface may be utilized to provide a pull-tab against a KIV-7 unit 700 once inserted into the quick insert/quick release mounting bracket 100.

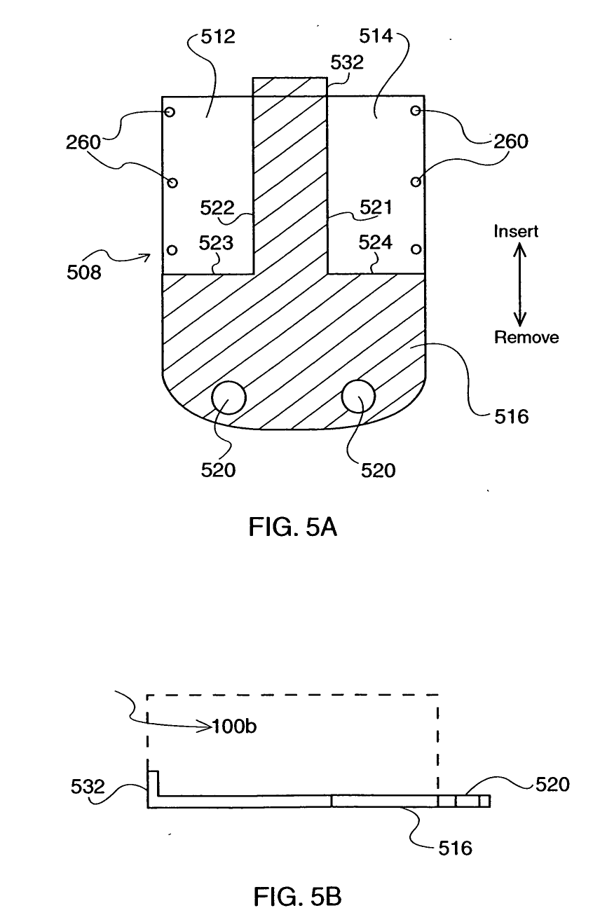

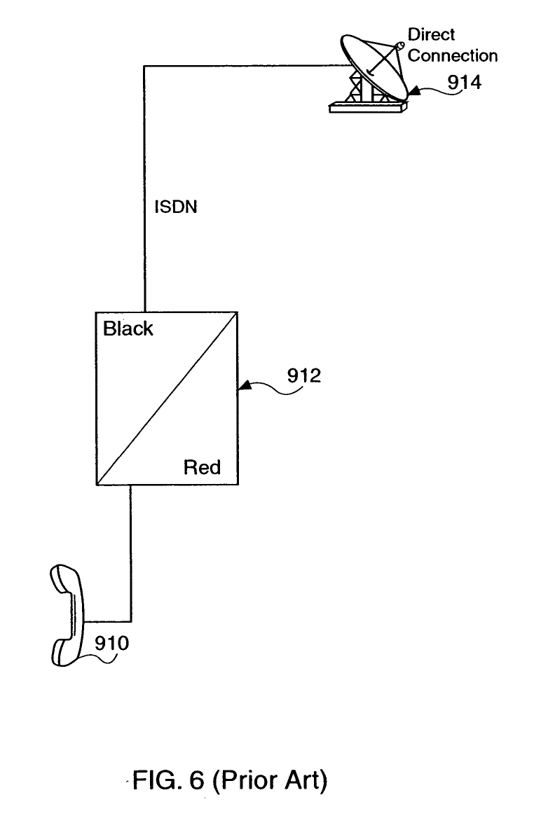

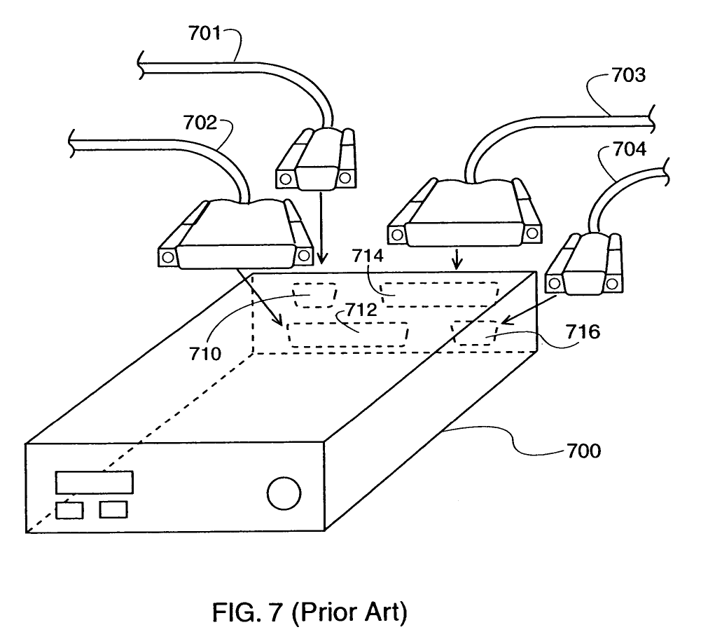

For instance, FIGS. 5A and 5B show an exemplary separable T-shaped pull 516 to allow quick separation of an installed KIV-7 unit 700 from a quick insert/quick release encryption unit mounting bracket 100b, in accordance with another aspect of the present invention.

In particular, FIG. 5A shows a T-shaped pull 516 formed from a portion of the bottom plate 508 of the mounting bracket 100b. The T-bracket 516 may be formed merely by cutting a bottom plate 506 along cut lines 521-524 to separate the T-shaped pull 516 from the remaining portions 512, 514 of the bottom plate.

Importantly, the T-shaped pull 516 includes a lip 532 that extends upwards behind the KIV-7. The rear plate 202 preferably includes a matching cut-out area to accommodate the gripping lip 532.

The T-shaped pull 516 includes finger holes 520 allowing a user to grab hold of the T-shaped pull 516 and pulling it in the ‘REMOVE’ direction of the arrow shown in FIG. 5A to remove both the T-shaped pull 516 together with the KIV-7 previously inserted into the mounting bracket 100.

The T-shaped pull 516 may be secured when inserted into the mounting bracket 100 merely within the tolerances created between a surface upon which the bottom of the mounting bracket 100 is resting on, and the bottom of the KIV-7 700. If desired, the T-shaped pull 516 may include tongue and groove (or other shape) type mating along edges 521, 522 with the remaining surfaces 512, 514 of the bottom plate 508.

The disclosed encryption unit mounting bracket 100 allows for use of an encryption unit 700 such as the KIV-7 in areas where space is extremely limited, such as in a deployable secure communication system.

The disclosed encryption unit mounting bracket 100 does not require securing of any physical connection of any cable assemblies, and thus, requires no hand tools. An individual may insert and remove an encryption unit 700 such as a KIV-7 in just a few seconds, not minutes as in conventional devices utilizing the KIV-7 encryption unit 700.

Moreover, the sizing of the encryption unit mounting bracket 100, and the need for operator access only to the front of the encryption unit 700, the overall size of a product such as a deployable secure communication system can be reduced.

The disclosed quick insert/quick release encryption unit mounting bracket 100 is constructed of any suitable sturdy material, e.g., aluminum or steel, or even a high quality plastic material. The encryption unit mounting bracket 100 comprises five individually manufactured sections (top, bottom, sides and rear), though one or all four of the top, bottom and sides of the mounting bracket 100 may be formed or otherwise manufactured as a single piece. The rear plate is importantly not formed with the top, bottom and sides, to allow adjustment to a wide range in tolerance experienced in mounting of rear connectors on typical KIV-7 units 700.

Individual side and top sections are assembled with high quality screws and the rear plate 202 is designed to float so as to allow for minor alignment differences in the rear panel connectors of the KIV-7 700.

The cable assemblies/connectors are fixed to the rear panel 202 with screws, but importantly the back panel 202 is allowed to freely float in the back end of the mounting bracket 100 to allow for a significantly large variation in physical tolerances in the placement of connectors on the back of the encryption unit 700.

While the invention has been described with reference to the exemplary embodiments thereof, those skilled in the art will be able to make various modifications to the described embodiments of the invention without departing from the true spirit and scope of the invention.

1. A mounting bracket for an encryption unit, comprising:
a top surface;
a right surface secured to said top surface;
a bottom surface secured to said right surface;
a left surface secured to said top surface; and
a rear surface having at least four connectors mounted thereon, said connectors being normally associated with individually secured cables;
wherein said rear surface is movably secured in a rear of said mounting bracket so as to allow for a given amount of left/right and up/down tolerance in alignment between said at least four mounted connectors mounted on said rear surface and a matching at least four connectors on a rear of an encryption unit to be slid over said top surface, said bottom surface, said left surface, and said right surface, and into connection with said at least four mounted connectors.

2. The mounting bracket for an encryption unit according to claim 1, wherein:
said at least four mounted connectors are fixedly mounted to said rear surface.

3. The mounting bracket for an encryption unit according to claim 1, wherein:
said mounting bracket is secured in a deployable communication system.

4. The mounting bracket for an encryption unit according to claim 1, further comprising:
a slideable portion formed in one of said top, bottom, right or left sides of said encryption unit mounting bracket, said slideable portion including:
a lip to grip an encryption unit installed into said encryption unit mounting bracket, and
a pull portion to allow a person to securely slide said slideable portion such that said encryption unit installed in said encryption unit mounting bracket is disconnected from said at least 4 mounted connectors secured to said rear surface.

5. The mounting bracket for an encryption unit according to claim 4, wherein:
said slideable portion is formed in said bottom surface of said mounting bracket.

6. The mounting bracket for an encryption unit according to claim 1, further comprising:
cut-out areas in said bottom surface of said mounting bracket.

7. The mounting bracket for an encryption unit according to claim 1, wherein:
said rear surface is a panel captured in a slot in at least said top surface and said bottom surface of said encryption unit mounting bracket.

8. The mounting bracket for an encryption unit according to claim 1, further comprising:
a slideable pull portion in one of said top surface and said bottom surface;
wherein said slideable pull portion grips an encryption unit mounted in said mounting bracket and allows an operator to quickly disconnect said encryption unit from said at least 4 mounted connectors.

9. The mounting bracket for an encryption unit according to claim 1, wherein:
said encryption unit is a Type 1 encryption unit.

10. The mounting bracket for an encryption unit according to claim 1, wherein:
said encryption unit is a KIV-7 encryption unit.

11. The mounting bracket for an encryption unit according to claim 1, wherein:
said mounting bracket is formed primarily from a plastic material.

12. The mounting bracket for an encryption unit according to claim 1, wherein:
said mounting bracket is formed primarily from a metal.

13. The mounting bracket for an encryption unit according to claim 1, wherein:
said metal is aluminum.

14. The mounting bracket for an encryption unit according to claim 1, wherein:
said metal is titanium.
